(19) United States
(12) Patent Application Publication
(10) Pub. No.: US 2025/0259616 A1
(43) Pub. Date: Aug. 14, 2025

(54) METHOD FOR DIAGNOSING FAILURE OF ACTIVE NOISE CANCELLING SYSTEM FOR MOBILE VEHICLES

(71) Applicant: HYUNDAI MOBIS CO., LTD., Seoul (KR)

(72) Inventor: Hyung Sub LIM, Yongin-si (KR)

(73) Assignee: HYUNDAI MOBIS CO., LTD., Seoul (KR)

(21) Appl. No.: 19/050,205

(22) Filed: Feb. 11, 2025

(30) Foreign Application Priority Data
Dec. 18, 2023 (KR) 10-2023-0184024

(51) Int. Cl. G10K 11/178; G07C 5/08

(52) U.S. Cl. CPC G10K 11/17835; G07C 5/0825; G10K 2210/12821; G10K 2210/3046; G10K 2210/503

(57) ABSTRACT

A method of diagnosing a failure of an active noise control system of the present invention may receive a sound wave transmission function A and a sound wave transmission function A′from a controller, measure a sound wave transmission function a while a vehicle is stationary and a sound wave transmission function a′ while the vehicle travels, determine whether an active noise control system operates normally on the basis of similarity between a and A and similarity between a′ and A′, and notify a user of a failure state of the active noise control system when the active noise control system is determined as not operating normally.

### CROSS REFERENCE TO RELATED APPLICATION

The present application claims priority to Korean Patent Application No. 10-2023-0184024, filed on Dec. 18, 2023, the entire contents of which are incorporated herein for all purposes by this reference.

### BACKGROUND OF THE INVENTION

### Field of the Invention

The present invention relates to a method of diagnosing a failure of an active noise control system, and more particularly, to a method of diagnosing a failure of an active noise control system for a movable body configured to control noise of the movable body and notifying a user of whether a failure occurs.

### Description of the Related Art

In order to reduce noise occurring when tires come into contact with a road surface, a method of actively reducing road surface noise refers to a method that measures vibration by using an acceleration sensor, analyzes the type and magnitude of noise, and then reduces the noise with canceling sound waves. For example, the canceling sound waves are generated before the road surface noise reaches an occupant, thereby reducing an interior noise level. Unlike a method using a sound absorber in the related art, it is possible to effectively reduce noise while equally maintaining a vehicle body weight.

However, because an interior of the vehicle is complex, sound waves, which are generated at a particular position, do not reach all seats while maintaining the constant magnitudes and phases. For example, road surface noise generated at a lower end of a driver seat is relatively less transmitted to a right rear seat. That is, the amount of noise, which is generated by vibration at a particular position and reaches the occupants, varies. A method of removing noise by using opposite-phase sound waves rather increases a magnitude of noise when the phase and the amplitude do not match. Therefore, the method of actively reducing road surface noise by using microphones and speakers smaller in number than the occupants may reduce noise only to minimum noise levels of all the seats. Further, the transmitted noise waveforms are also different because contact points between the road surface and the vehicle are four tires and structures such as suspension systems are different.

In order to solve the above-mentioned problems, a transmission function made by the

complex vehicle body and the vehicle interior structure is mimicked by autonomous learning, thereby providing road surface noise reduction performance beyond the limit of a simplified model.

FIG. 1 illustrates an active noise control system 10 in the related art. With reference to FIG. 1, the active noise control system 10 in the related art includes a sensor part 11 including a plurality of sensors mounted on axles of wheels of a vehicle and configured to detect ground surface vibration and acceleration, a microphone part 12 including a plurality of microphones respectively mounted in seats of the vehicle and configured to measure noise, a speaker part 13 including a plurality of speakers respectively mounted at sides adjacent to the seats of the vehicle, and a controller 14. The controller 14 actively removes noise by receiving a transmission function between the sensor part 11 and the microphone part 12 and a transmission function between the sensor part 11 and the speaker part 13.

However, as described above, in the active noise control system 10, the microphone part 12 and the sensor part 11 are connected to the controller 14 through a single wire, as illustrated in FIG. 2. Therefore, in order to identify whether the active noise control system 10 operates normally, the controller 14 transmits state check messages to the sensors and receives feedback data from the sensors.

However, in order to transmit the state check messages to the sensors and receive the feedback data from the sensors, the state check messages and the feedback data need to pass through all the sensors placed between the controller 14 and the corresponding sensors. For this reason, there is a problem in that it is impossible to identify whether the active noise control system 10 operates normally in case that any one sensor fails or the wire is short-circuited.

### SUMMARY OF THE INVENTION

The present invention is proposed to solve these problems and aims to provide a method of diagnosing a failure of an active noise control system, the method being capable of identifying whether some or all of sensor parts and microphone parts in the active noise control system operate normally.

The present invention also aims to provide a method of diagnosing a failure of an active noise control system, the method being capable of identifying whether a vehicle operates normally while the vehicle travels or is stationary after the vehicle is released to a user.

The present invention also aims to provide a method of diagnosing a failure of an active noise control system, the method being capable of notifying a user of whether an active noise control system operates normally.

Technical problems to be solved by the present invention are not limited to the above-mentioned technical problems, and other technical problems, which are not mentioned above, may be clearly understood by those skilled in the art from the following descriptions.

The present invention provides a method of diagnosing a failure of an active noise control system. One embodiment provides a method of diagnosing a failure of an active noise control system including a sensor part including a plurality of sensors mounted in the vicinity of wheels of a vehicle and configured to detect a road surface vibration, a microphone part including a plurality of microphones mounted in regions corresponding to seats of the vehicle and configured to measure noise, and a speaker part including a plurality of speakers mounted in doors of the vehicle, the method including: a vehicle development step of measuring and storing a sound wave transmission function A between the speaker part and the microphone part and a sound wave transmission function A′ between the sensor part and the microphone part before the vehicle is released; and a diagnosis step of determining, by a diagnosis part, whether the active noise control system operates normally by measuring a sound wave transmission function a while the vehicle is stationary and a sound wave transmission function a′ while the vehicle travels and calculating similarity between a and A and similarity between a′ and A′ after the vehicle is released.

In the embodiment, before the diagnosis step, whether the sensor part, the microphone part, the speaker part, and the diagnosis part are connected may be determined when the vehicle is turned on.

In the embodiment, the diagnosis step may include: a traveling diagnosis step of calculating the similarity between a′ and A′; and a stationary diagnosis step of calculating the similarity between a and A.

In the embodiment, the traveling diagnosis step and the stationary diagnosis step may be sequentially performed.

In the embodiment, the similarity between a′ and A′ may be calculated by measuring the sound wave transmission function a′ while the vehicle travels in the traveling diagnosis step, the stationary diagnosis step may be performed when the similarity between a′ and A′ is a preset numerical value or more, and a user may be notified of a failure state of the active noise control system when the similarity is less than the preset numerical value.

In the embodiment, the sound wave transmission function A′may include a sound wave transmission function A1′ stored in a normal state in which no noise occurs at the periphery, and a sound wave transmission function A2′ stored in a state in which noise occurs at the periphery, and a section in which A1′ and A2′ are not matched may be excluded when the similarity between a′ and A′ is calculated in the traveling diagnosis step.

In the embodiment, the similarity between a′ and A′ may be determined on the basis of a tendency of a graph of a noise value over time and a degree to which a noise value of a′ deviates from a noise value of A′in a set section.

In the embodiment, the stationary diagnosis step may include collecting peripheral noise and calculating the similarity between a and A when the collected noise is lower than a preset numerical value x.

In the embodiment, the stationary diagnosis step may include a distortion prevention step of collecting the peripheral noise and preventing distortion of a when the collected noise is higher than a preset numerical value x1, and the distortion prevention step may include: 1) setting a basic noise data value for each frequency by converting pre-stored noise collection data into a frequency scale; 2) measuring the peripheral noise; and 3) correcting the measured peripheral noise by excluding the basic noise data value collected in process 1) from the peripheral noise measured in process 2).

In the embodiment, the stationary diagnosis step may include collecting peripheral noise and transmitting a vehicle movement request message or a quietness request message to a user when the collected noise is higher than a preset numerical value x2 (x2>x1).

### BRIEF DESCRIPTION OF THE DRAWINGS

FIGS. 1 to 2 are views illustrating an active noise control system in the related art.

FIG. 3 is a configuration view illustrating a diagnosis device of an active noise control system according to an embodiment of the present invention.

FIG. 4 is a view illustrating a state in which the active noise control system according to the embodiment of the present invention is mounted in a vehicle.

FIGS. 5 and 6 are views illustrating a sound wave transmission function according to the embodiment of the present invention.

FIG. 7 is a view illustrating an appearance of a notification part according to the embodiment of the present invention.

FIG. 8 is a flowchart illustrating a method of diagnosing the active noise control system according to the embodiment of the present invention.

FIG. 9 is a graph illustrating the sound wave transmission function over time while a traveling diagnosis step according to the embodiment of the present invention is performed.

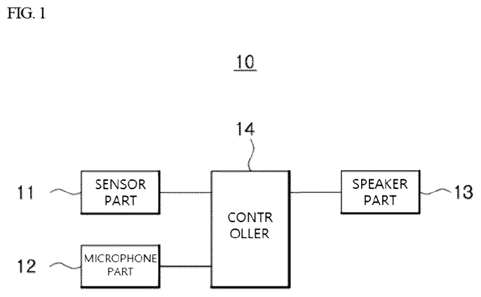

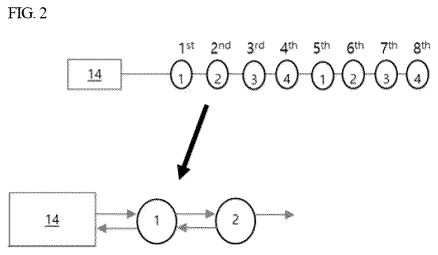

### DETAILED DESCRIPTION OF THE INVENTION

The objects, features, and advantages of the present invention will become more apparent with reference to the following embodiments associated with the accompanying drawings. Specific structural or functional descriptions of embodiments of the present invention are exemplified only for the purpose of explaining the embodiments according to the concept of the present invention, the embodiments according to the concept of the present invention may be carried out in various forms, and it should not be interpreted that the present invention is limited to the embodiments described in this specification or application. Because the embodiments according to the concept of the present invention may be variously changed and may have various forms, specific embodiments will be illustrated in the drawings and described in detail in the present specification or application. However, the descriptions of the specific embodiments are not intended to limit embodiments according to the concept of the present invention to the specific embodiments, but it should be understood that the present invention covers all modifications, equivalents and alternatives falling within the spirit and technical scope of the present invention. The terms such as “first” and/or “second” may be used to describe various constituent elements, but these constituent elements should not be limited by these terms. These terms are used only for the purpose of distinguishing one constituent element from other constituent elements. For example, without departing from the scope according to the concept of the present invention, the first constituent element may be referred to as the second constituent element, and similarly, the second constituent element may also be referred to as the first constituent element. When one constituent element is described as being “connected” or “coupled” to another constituent element, it should be understood that one constituent element can be connected or coupled directly to another constituent element, and an intervening constituent element can also be present between the constituent elements. When one constituent element is described as being “connected directly to” or “coupled directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner. The terms used in the present specification are used only for the purpose of describing particular embodiments and are not intended to limit the present invention. Singular expressions include plural expressions unless clearly described as different meanings in the context. In the present application, it will be appreciated that terms “including” and “having” are intended to designate the existence of characteristics, numbers, steps, operations, constituent elements, and components described herein or a combination thereof, and do not exclude a possibility of the existence or addition of one or more other characteristics, numbers, steps, operations, constituent elements, and components, or a combination thereof in advance. Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present specification. Hereinafter, the present invention will be described in detail by describing the embodiments of the present invention with reference to the accompanying drawings. Like reference numerals indicated in the respective drawings refer to like members.

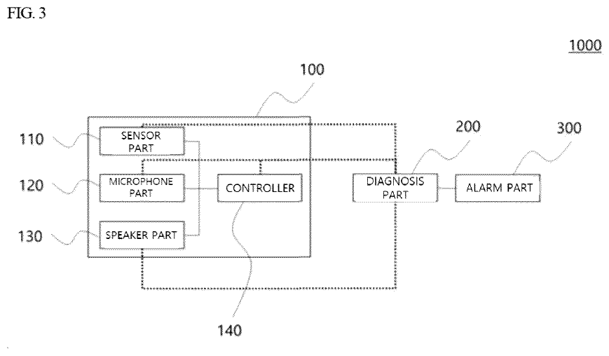

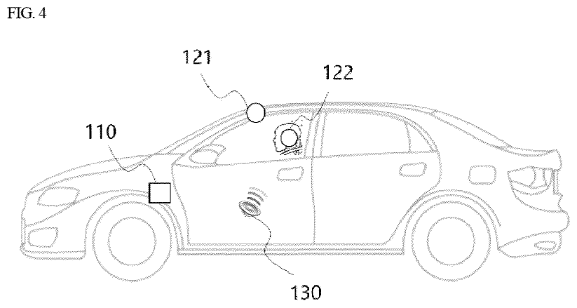

FIG. 3 is a configuration view illustrating a diagnosis device 1000 of an active noise control system according to an embodiment of the present invention, and FIG. 4 is a view illustrating a state in which the active noise control system 100 according to the embodiment of the present invention is mounted in a vehicle.

With reference to FIG. 3, the diagnosis device 1000 of the active noise control system of the present invention includes the active noise control system 100, a diagnosis part 200, and a notification part 300.

For example, the active noise control system 100 includes sensor parts 110, microphone parts 120, speaker parts 130, and a controller 140.

The sensor parts 110 may be respectively mounted on axles of wheels of the vehicle and detect a ground surface vibration. For example, the sensor part 110 may be implemented as various sensors, such as a vibration sensor and an acceleration sensor, that detect ground surface vibrations. For example, the sensor part 110 may be provided as an acceleration sensor configured to measure accelerations along three axes, i.e., x, y, and z axes.

For example, as illustrated in FIG. 4, the sensor part 110 may be mounted in the vicinity of the axles of the four wheels, detect ground surface vibrations, and transmit vibration signals to the controller 140. This configuration is based on an example in which the vehicle has four wheels. The number of sensor parts may also vary correspondingly depending on the number of wheels of the vehicle.

Because the wheels of the vehicle support a weight of the vehicle, the road surface vibrations are transmitted to the vehicle interior along the axles and generate sound waves while the vehicle travels. Therefore, the sensor part 110 is mounted on the axle through which the ground surface vibration is transmitted from the wheel to a vehicle body, such that the vibration may be independently measured for each position. Therefore, it is possible to cope with noise generated at a time point at which the front wheels are vibrated by an irregular road surface and the rear wheels travel on a flat road.

The microphone part 120 may measure noise to be transmitted to an occupant and transmit the measured microphone signal to the controller 140.

For example, the microphone part 120 includes a first microphone part 121 and a second microphone part 122. The first microphone part 121 may be mounted in a ceiling of the vehicle and measure noise. For example, the first microphone part 121 may be mounted at a position corresponding to a location above the seat of the vehicle.

For example, the second microphone parts 122 may be respectively mounted in the seats of the vehicle and measure noise. The second microphone part 122 is mounted in a headrest of the seat closest to a position of an ear of the occupant, such that the second microphone part 122 may measure noise similar to noise to be transmitted to the occupant. For example, the second microphone parts 122 may be mounted at two opposite sides of the headrest.

The data measured by the microphone part 120 may not only be used to monitor an interior noise level but also used for a process of generating an answer key for a method of generating opposite phase sound waves.

For example, any one of the first microphone part 121 and the second microphone part 122 may be removed from the inside of the vehicle after the sound wave transmission function, which will be described below, is acquired before the vehicle is released. Alternatively, on the contrary, the vehicle may be released in the state in which both the first microphone part 121 and the second microphone part 122 are mounted in the vehicle.

The speaker part 130 outputs a sound in order to acquire the sound wave transmission functions to be described below. For example, the speaker part 130 may output a speaker output signal with sine waves while changing a frequency from a starting frequency to an ending frequency. In this case, the starting frequency may be a frequency lower than the ending frequency, and the frequency may be changed at a predetermined frequency interval (Δf). When the speaker part 130 outputs the sine waves while changing the frequency, the controller 140 may obtain the sound wave transmission functions by measuring a change in magnitude of the microphone signal and a phase difference.

In addition, the speaker part 130 outputs a sound to remove noise. For example, the speaker part 130 may remove the noise measured by the microphone part 120 by outputting a second speaker signal with an opposite phase to a first speaker signal generated by the controller 140 by using a vibration signal measured by the sensor part 110.

The speaker parts 130 may be respectively mounted in the vicinity of the seats of the vehicle and output the second speaker signal with the opposite phase to the first speaker signal generated by the controller 140. In this case, as illustrated in FIG. 4, the speaker part 130 may be mounted in each of the seats.

The speaker part 130 may remove noise by generating sound waves with the opposite phase to the noise that reaches each of the seats. Because a general speaker transmits sound waves in all directions, the sound waves generated by the speaker in the driver seat also reach the other occupants. For example, the speaker part 130 may use a directional speaker with a beam-focusing technique in order to eliminate this interaction. In this case, the speaker part 130 may include a beam-focusing directional speaker with an annular array shape.

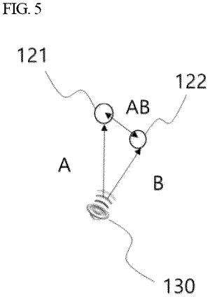

The controller 140 may calculate the sound wave transmission function between the first microphone part 121 and the second microphone part 122 by measuring the sound wave transmission function between the speaker part 130 and the microphone part 120 in a vehicle development step before the vehicle is released. This configuration is used to exhibit an active noise reduction function or diagnose the active noise control system when the vehicle is stationary. For example, the controller 140 measures the sound wave transmission function between the speaker part 130 and the microphone part 120. For example, as illustrated in FIG. 5, the controller 140 measures a sound wave transmission function A between the speaker part 130 and the first microphone part 121 and measures a sound wave transmission function B between the speaker part 130 and the second microphone part 122. A sound wave transmission function AB between the microphone parts 121 and 122 is measured by using the acquired sound wave transmission functions A and B. The sound wave transmission functions are stored in the controller 140. When the sound wave transmission function AB is used, it is possible to exhibit the active noise control reduction function or diagnose the active noise control system even though any one of the two microphone parts 121 and 122 is removed when the vehicle is released.

For example, the controller 140 may measure the sound wave transmission function for each of the microphones by comparing the speaker output signal outputted from each of the speakers and the microphone signal measured by each of the microphones while changing the frequency from the starting frequency to the ending frequency.

In this case, the speaker may output the speaker output signal with the sine waves while changing the frequency from the starting frequency to the ending frequency, and the microphone may measure noise in response to the speaker output signal and transmit the microphone signal to the controller 140. The speaker may output the speaker output signal while changing the frequency by a magnitude (Δf) from a low frequency to a high frequency, and the controller 140 may measure a change in magnitude and a change in phase for each frequency of the frequency output signal.

Then, the controller 140 may record a magnitude and a phase difference for each frequency between the microphone signal and the speaker output signal. In case that the frequency reaches the ending frequency, the controller 140 may calculate a frequency response by using the magnitude and the phase difference for each frequency and perform an inverse Fourier transform on the frequency response, thereby measuring the sound wave transmission function for each of the microphones.

Hereinafter, a configuration will be described in which the second microphone part 122 is removed from the inside of the vehicle after the sound wave transmission functions to be described below is acquired before the vehicle is released, and the vehicle is released in the state in which only the first microphone part 121 is mounted.

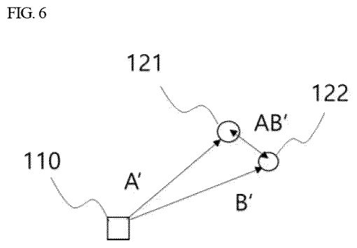

Alternatively, in the vehicle development step before the vehicle is released, the controller 140 may calculate the sound wave transmission function between the first microphone part 121 and the second microphone part 122 by measuring the sound wave transmission function between the sensor part 110 and the microphone part 120. This configuration is provided to apply external noise or the like transmitted through the sensor part 110 while the vehicle travels, and the configuration is used to exhibit the active noise reduction function or diagnose the active noise control system while the vehicle travels. For example, as illustrated in FIG. 6, the controller 140 measures a sound wave transmission function A′ between the sensor part 110 and the first microphone part 121 and measures a sound wave transmission function B′ between the sensor part 110 and the second microphone part 122. A sound wave transmission function AB′ between the microphone parts 121 and 122 is calculated by using the acquired sound wave transmission function A′and B′. When the sound wave transmission function AB′ is used, it is possible to exhibit the active noise control reduction function or diagnose the active noise control system even though any one of the two microphone parts 121 and 122 is removed when the vehicle is released.

For example, the controller 140 may measure the sound wave transmission function for each of the microphones by comparing the sensor output signal outputted from each of the sensors and the microphone signal measured by each of the microphones while changing the frequency from the starting frequency to the ending frequency. Like the speaker, the sensor may assume a situation in which noise occurs, and the sensor may output an output signal while changing a frequency and transmit the output signal to the controller 140. Alternatively, under an environment in which various types of noise occur actually, the speaker may output the output signal and transmit the output signal to the controller 140. The process in which the controller 140 measures and calculates the sound wave transmission function is similar to the process of measuring and calculating the sound wave transmission function between the speaker part 130 and the microphone part 120.

The controller 140 stores the measured and calculated sound wave transmission function, and then the controller 140 transmits the corresponding sound wave transmission function to the diagnosis part 200 in order to identify whether the active noise control system 100 operates normally.

The diagnosis part 200 identifies whether the active noise control system 100 operates normally after the vehicle is released and delivered to the user. For example, the diagnosis part 200 may include an amplifier 210 (AMP). For example, the amplifier 210 may be individually connected to the sensor part 110, the microphone part 120, the speaker part 130, and the controller 140 in the active noise control system 100. The diagnosis part 200 transmits an error signal to the notification part 300 when the active noise control system 100 does not operate normally.

When the diagnosis part 200 determines that the active noise control system 100 does not operate normally, the notification part 300 receives an error signal and transmits an error message to the user. Alternatively, the notification part 300 may transmit a diagnosis process of the active noise control system 100 through the diagnosis part 200 or transmit a message to the user asking whether to perform a diagnosis manually in case that the diagnosis part 200 determines that the active noise control system 100 needs to be diagnosed.

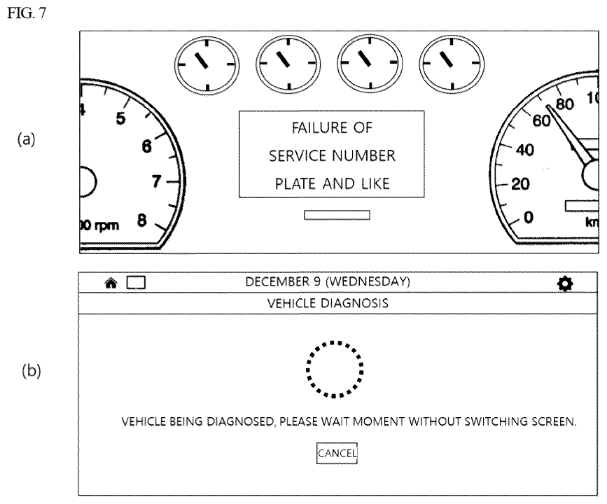

FIG. 7 is a view illustrating an appearance of the notification part 300 according to the embodiment of the present invention. With reference to FIG. 7, the notification part 300 may be provided as a display screen. For example, the notification part 300 may be provided to a cluster, as illustrated in FIG. 7A, or the notification part 300 may be provided as a separate display screen for displaying navigation or the like, as illustrated in FIG. 7B. For example, the notification part 300 may provide an auditory alarm while displaying an error message on the display screen.

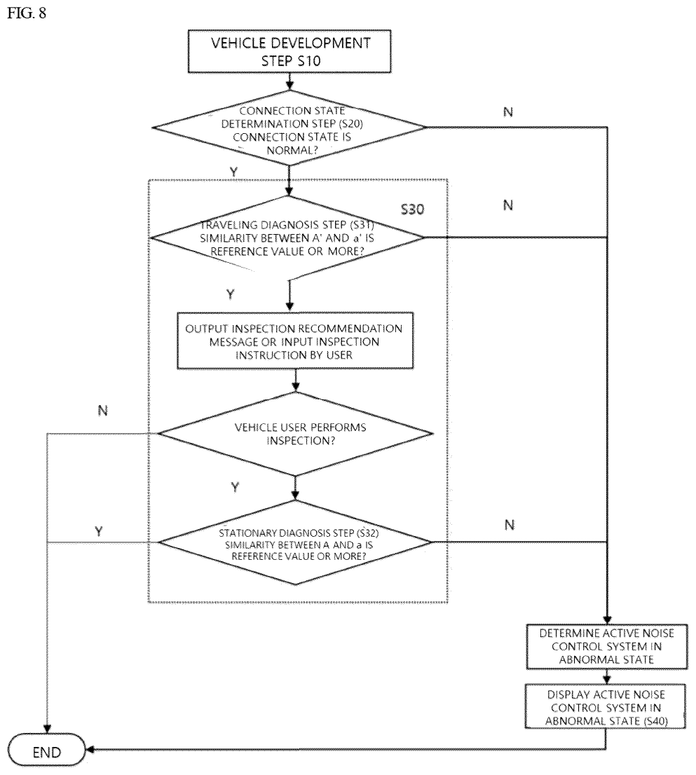

FIG. 8 is a flowchart illustrating a method of diagnosing the active noise control system according to the embodiment of the present invention. Hereinafter, the method of diagnosing the active noise control system may be performed by the amplifier 210.

With reference to FIG. 8, the method of diagnosing the active noise control system may include a vehicle development step S10, a connection state determination step S20, a diagnosis step S30, and a display step S40.

For example, in the vehicle development step S10, the controller 140 calculates and stores the above-mentioned sound wave transmission functions before the vehicle is released.

As illustrated in FIG. 5, in the vehicle development step S10, the sound wave transmission function AB between the first microphone part 121 and the second microphone part 122 by measuring the sound wave transmission function A between the speaker part 130 and the first microphone part 121 and the sound wave transmission function B between the speaker part 130 and the second microphone part 122. In addition, as illustrated in FIG. 6, the sound wave transmission function AB′ between the first microphone part 121 and the second microphone part 122 is calculated by measuring the sound wave transmission function A′between the sensor part 110 and the first microphone part 121 and the sound wave transmission function B′ between the sensor part 110 and the second microphone part 122.

The controller 140 stores the sound wave transmission function. For example, in the vehicle development step S10, the second microphone part 122 is removed after the sound wave transmission function is calculated, and the vehicle may be released in the state in which only the first microphone part 121 is mounted.

For example, in the connection state determination step S20, whether the amplifier 210 is connected to the sensor part 110, the microphone part 120, the speaker part 130, and the controller 140 in the active noise control system 100 is identified. For example, the components in the amplifier 210 and the active noise control system 100 may transmit and receive signals by means of a method such as CAN communication. For example, the connection state determination step S20 may be performed after the vehicle is released and delivered to the user. For example, the connection state determination step S20 may be performed when the user turns on the vehicle. In the connection state determination step S20, in case that there is a problem with a connection state between the amplifier 210 and the components in the active noise control system 100, the display step S40 may be performed and transmit a message related to a failure state to the user through the notification part 300.

The diagnosis step S30 is performed in case that there is no abnormality in the connection state determination step S20.

In the diagnosis step S30, whether the active noise control system 100 operates normally. The diagnosis step S30 includes a traveling diagnosis step S31 and a stationary diagnosis step S32. The traveling diagnosis step S31 is performed while the vehicle travels at a predetermined speed, and the stationary diagnosis step S32 is performed at a time point at which no speed is applied to the vehicle.

In the display step S40, the notification part 300 notifies the user of whether the active noise control system 100 operates normally. Alternatively, in the display step S40, the notification part 300 may display state information related to the diagnosis process of the active noise control system 100. For example, the notification part 300 may display a vehicle diagnosis guidance and a situation in which the vehicle diagnosis is being performed in the form of a pop-up or an instruction message. The corresponding message may be excluded, simplified, or specified in accordance with the user convenience.

In case that the active noise control system 100 does not operate normally, the notification part 300 may display an addition guidance such as ‘Please visit the nearest A/S center to check the active noise control system.’ Alternatively, the notification part 300 may also display a guidance such as ‘Would you like to automatically turn off the active noise control system until the system is repaired?’

For example, the traveling diagnosis step S31 and the stationary diagnosis step S32 may be sequentially performed. For example, the traveling diagnosis step S31 may be performed first, and the stationary diagnosis step S32 may be performed in case that the active noise control system 100 is determined as not being abnormal in the traveling diagnosis step S31. In case that the active noise control system 100 is determined as being abnormal in the traveling diagnosis step S31, the display step S40 may be performed and transmit a message related to a failure state to the user through the notification part 300.

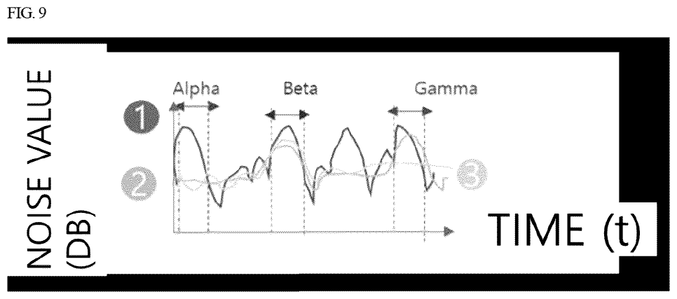

FIG. 9 is a graph illustrating the sound wave transmission function over time while the traveling diagnosis step S31 according to the embodiment of the present invention is performed.

For example, in the traveling diagnosis step S31, the sound wave transmission function is measured and calculated while the vehicle travels. In order to collect an effect such as vibration from a road surface while the vehicle travels, the sound wave transmission function between the sensor part 110 and the microphone part 120 is measured. For example, a traveling sound wave transmission function a′ between the sensor part 110 and the first microphone part 121 is measured. Further, whether the active noise control system 100 is abnormal is determined by comparing the measured traveling sound wave transmission function a′ and the sound wave transmission function A′ pre-stored in the vehicle development step S10. For example, the pre-stored sound wave transmission function A′ may include the sound wave transmission function A1′ stored in a normal state in which no noise occurs at the periphery, and the sound wave transmission function A2′ stored in a state in which noise occurs at the periphery. The sound wave transmission function A1′ may include road surface noise in the normal state that may occur while the vehicle travels. The sound wave transmission function A2′ may include other noise such as a music sound at the periphery and the user's voice in addition to the road surface noise in the normal state that may occur while the vehicle travels.

For example, zones are set over time, and whether the active noise control system 100 is abnormal is determined on the basis of a degree to which the traveling sound wave transmission function a′ measured in each of the zones deviates from the pre-stored sound wave transmission function A1′.

With reference to FIG. 9, the horizontal axis in the graph indicates the time, and the vertical axis indicates values of the measured sound. Graph \textcircled{1} shows the sound wave transmission function A2′ stored in the state in which noise occurs at the periphery, Graph \textcircled{2} shows the sound wave transmission function A1′ stored in the normal state in which no noise occurs at the periphery, and Graph \textcircled{3} shows the sound wave transmission function a′ measured while the vehicle travels.

In an alpha section, the tendencies of A1′ and A2′ graphs are not approximately consistent with each other, and noise in the alpha section is not determined as being the road surface noise.

That is, whether noise in the corresponding section is the road surface noise is determined on the basis of whether the tendencies of A1′ and A2′ graphs are consistent (matched) with each other. The alpha section is a region executed when the similarity between A1′ and a is determined.

In a beta section, the tendencies of A1′ and A2′ graphs are approximately consistent with each other, noise in the beta section is determined as the road surface noise, and the beta section is utilized to determine the similarity between A1′ and a. The measured a′ in Graph \textcircled{3} is approximately consistent with A1′ in the beta section. Whether the graph is consistent is determined by setting the tendencies of the graph and a reference range of a noise value based on A1′. Assuming that a′ in Graph \textcircled{3} measured in the beta section is consistent in the tendency with A1′ in the beta section and a′ is positioned in a reference range from A1′, the amplifier 210 determines that the active noise control system 100 operates normally.

In a gamma section, the tendencies of A1′ and A2′ graphs are approximately consistent with each other, the noise in the beta section is determined as the road surface noise. The gamma section is utilized to determine the similarity between A1′ and a. The measured a′ in Graph \textcircled{3} is not approximately consistent with A1′ in the gamma section. Whether the graph is consistent is determined by setting the tendencies of the graph and the reference range of the noise value based on A1′. Assuming that a′ in Graph \textcircled{3} measured in the gamma section is not consistent in tendency with A1′ in the gamma section and a′ is not positioned in the reference range from A1′, the amplifier 210 determines that the active noise control system 100 operates abnormally or does not operate. When the active noise control system 100 is determined as operating abnormally or not

operating, the display step S40 is performed. In the display step S40, the notification part 300 displays an appropriate phrase based on the determination of the situation, such as ‘Please check the active noise control system’ or ‘Active noise control sensor failure’ or outputs the phrase as a sound.

For example, the traveling diagnosis step S31 may be automatically performed in a preset cycle.

The stationary diagnosis step S32 is performed in case that the active noise control system 100 is determined as not being abnormal in the traveling diagnosis step S31.

Whether the active noise control system 100 is abnormal is determined when the vehicle is stationary in the stationary diagnosis step S32. For example, the stationary diagnosis step S32 may be performed manually. For example, the stationary diagnosis step S32 may be performed by the user. A progress button or a cancel button may be provided on a cluster or a navigation system that is the notification part 300. The stationary diagnosis step S32 may be performed in accordance with the user's intention. Alternatively, in the stationary diagnosis step S32, a test may be recommended for the cluster and the navigation as a pop-up message or a general message.

When the stationary diagnosis step S32 is performed, the notification part 300 may provide a warning message that states that a sound may be emitted from the speaker and a cautionary message asking the occupant to remain silent for a moment.

For example, the stationary diagnosis step S32 may be performed only in case that peripheral noise is received by the microphone part 120 and the peripheral noise has a reference value or less. In the stationary diagnosis step S32, the speaker part 130 generates a sound having a predetermined frequency and a magnitude, and the microphone part 120 receives the sound.

The speaker outputs a particular sound, e.g., sine waves or white noise for a predetermined period of time, and the data include several bandwidths. That is, by performing frequency conversion, the sound source and the sound collected after being output may be compared for each frequency bandwidth. With the above-mentioned process, the sound wave transmission function a between the speaker part 130 and the microphone part 120 is calculated. Further, whether the active noise control system 100 is abnormal is determined by comparing the measured stationary sound wave transmission function a and the sound wave transmission function A pre-stored in the vehicle development step S10.

The method of comparing the similarities of the measured stationary sound wave transmission function a and the pre-stored sound wave transmission function A determines the pre-stored sound wave transmission function A on the basis of a degree to which the pre-stored sound wave transmission function A deviates from the tendencies of the graph and the reference range of the noise value. In case that the similarity has the reference value or more, the active noise control system 100 is determined as being in the normal state. Otherwise, the active noise control system 100 is determined as being in the abnormal state.

When the active noise control system 100 is determined as operating abnormally or not operating, the display step S40 is performed. In the display step S40, the notification part 300 displays an appropriate phrase based on the determination of the situation, such as ‘Please check the active noise control system’ or ‘Active noise control sensor failure’ or outputs the phrase as a sound.

FIG. 10 illustrates a flowchart of the stationary diagnosis step S32 according to the embodiment of the present invention. With reference to FIG. 10, for example, the stationary diagnosis step S32 may include a noise measurement step S321 and a distortion prevention step S322 or an alarm step S323.

First, in the noise measurement step S321, the peripheral noise collected by the microphone part 120 is collected for a predetermined period of time, e.g., for several seconds.

In case that the collected noise is lower than a preset numerical value, it is determined that there is no problem in performing the stationary diagnosis step S32, such that the above-mentioned process of comparing the sound wave transmission functions a and A is performed.

However, in case that the collected noise is higher than the preset numerical value, it is determined that there is a problem in performing the stationary diagnosis step S32, such that the distortion prevention step S322 or the alarm step S323 is performed.

The distortion prevention step S322 is performed in case that the peripheral noise exists at a partial portion, and the stationary diagnosis step S32 may be performed, but the noise measurement performance is low. The alarm step S323 is performed in case that the peripheral noise is excessively high and it is expected that the stationary diagnosis step S32 cannot be performed.

A threshold value, which is a reference value for separating the steps, may be determined by the existing experimental result.

The distortion prevention step S322 is performed by the flowing processes.
a) A basic noise value for each frequency by converting noise collection data performed in advance in the vehicle development step S10 into a frequency scale.
b) A sound at the periphery of the vehicle is collected to start the stationary diagnosis step S32. When sine waves are outputted for each speaker, the collected sound contains the basic noise value and the value mixed with the additionally collected sine waves.
c) A negative pressure level DB of the noise collection data collected in the process a) from the collected sound, and only the remaining value, which excludes the basic noise value, is set and corrected to a significant value of the input data. This process is performed after the conversion into the frequency scale.
d) The stationary diagnosis step S32 is performed by the sound corrected by the process c).

The above-mentioned processes may prevent a transmission function distortion in the stationary diagnosis step S32.

In the alarm step S323, a guidance or a pop-up message is displayed on the notification part 300. In the example, the pop-up message may be provided as follows: ‘Please park the vehicle in a quieter location and restart the inspection. Please remain quiet until the inspection is complete.’

The above-mentioned example has been described in which the microphone part 120 includes both the first microphone part 121 and the second microphone part 122. On the contrary, the microphone part 120 may include only at least any one of the first microphone part 121 and the second microphone part 122.

According to the present invention, it is possible to identify whether not only some of the sensor parts and the microphone parts in the active noise control system but also all the sensor parts and the microphone parts operate normally.

In addition, according to the present invention, it is possible to identify whether the vehicle operates normally while the vehicle travels or is stationary after the vehicle is released to the user.

In addition, according to the present invention, it is possible to notify the user of whether the active noise control system operates normally.

According to the present invention, it is possible to identify whether not only some of the sensor parts and the microphone parts in the active noise control system but also all the sensor parts and the microphone parts operate normally.

In addition, according to the present invention, it is possible to identify whether the vehicle operates normally while the vehicle travels or is stationary after the vehicle is released to the user.

In addition, according to the present invention, it is possible to notify the user of whether the active noise control system operates normally.

The effects of the present invention are not limited to the above-mentioned effects, and other effects, which are not mentioned above, may be clearly understood by those skilled in the art from the present specification and the accompanying drawings.

While the exemplary embodiments of the present invention have been described above, the embodiments disclosed in the present invention are merely illustrative without limiting the technical spirit of the present invention. Therefore, the technical spirit of the present invention includes not only each of the disclosed embodiments, but also a combination of the disclosed embodiments, and furthermore, the scope of the technical spirit of the present invention is not limited by these embodiments. Furthermore, those skilled in the art to which the present invention pertains may make a number of changes and modifications to the present invention without departing from the spirit and scope of the appended claims, and all such appropriate changes and modifications should be considered as equivalents falling within the scope of the present invention.

What is claimed is:

1. A method of diagnosing a failure of an active noise control system comprising a sensor part comprising a plurality of sensors mounted in the vicinity of wheels of a vehicle and configured to detect a road surface vibration, a microphone part comprising a plurality of microphones mounted in regions corresponding to seats of the vehicle and configured to measure noise, and a speaker part comprising a plurality of speakers mounted in doors of the vehicle, the method comprising:
a vehicle development step of measuring and storing a sound wave transmission function A between the speaker part and the microphone part and a sound wave transmission function A′ between the sensor part and the microphone part before the vehicle is released;
a diagnosis step of determining, by a diagnosis part, whether the active noise control system operates normally by measuring a sound wave transmission function a while the vehicle is stationary and a sound wave transmission function a′ while the vehicle travels and calculating similarity between a and A and similarity between a′ and A′ after the vehicle is released; and
in response to a determination that the active noise control system operates abnormally, causing a display to provide a message related to abnormal operation of the noise control system.

2. The method of claim 1, further comprising:
a connection state determination step of determining whether the sensor part, the microphone part, the speaker part, and the diagnosis part are connected when the vehicle is turned on before the diagnosis step.

3. The method of claim 1, wherein the diagnosis step comprises:
a traveling diagnosis step of calculating the similarity between a′ and A′; and
a stationary diagnosis step of calculating the similarity between a and A, and
wherein the traveling diagnosis step and the stationary diagnosis step are sequentially performed.

4. The method of claim 3, wherein the similarity between a′ and A′ is calculated by measuring the sound wave transmission function a′ while the vehicle travels in the traveling diagnosis step, the stationary diagnosis step is performed when the similarity between a′ and A′is a preset numerical value or more, and a user is notified of a failure state of the active noise control system when the similarity is less than the preset numerical value.

5. The method of claim 3, wherein the sound wave transmission function A′ comprises a sound wave transmission function A1′ stored in a normal state in which no noise occurs at the periphery, and a sound wave transmission function A2′ stored in a state in which noise occurs at the periphery, and
wherein a section in which A1′ and A2′ are not matched is excluded when the similarity between a′ and A′is calculated in the traveling diagnosis step.

6. The method of claim 5, wherein the similarity between a′ and A′ is determined on the basis of a tendency of a graph of a noise value over time and a degree to which a noise value of a′ deviates from a noise value of A′in a set section.

7. The method of claim 3, wherein the stationary diagnosis step comprises collecting peripheral noise and calculating the similarity between a and A when the collected noise is lower than a preset numerical value x.

8. The method of claim 7, wherein the stationary diagnosis step comprises a distortion prevention step of collecting the peripheral noise and preventing distortion of a when the collected noise is higher than a preset numerical value x1, and
wherein the distortion prevention step comprises:
1) setting a basic noise data value for each frequency by converting pre-stored noise collection data into a frequency scale;
2) measuring the peripheral noise; and
3) correcting the measured peripheral noise by excluding the basic noise data value collected in process 1) from the peripheral noise measured in process 2).

9. The method of claim 8, wherein the stationary diagnosis step comprises collecting peripheral noise and transmitting a vehicle movement request message or a quietness request message to a user when the collected noise is higher than a preset numerical value x2 (x2>x1).
